(19) United States
(12) Patent Application Publication
(10) Pub. No.: US 2025/0333571 A1
(43) Pub. Date: Oct. 30, 2025

(54) REPROCESSABLE NON-ISOCYANATE POLYTHIOURETHANE FOAMS AND CATALYST-FREE METHODS FOR THEIR SYNTHESIS AND REPROCESSING

(71) Applicant: Northwestern University, Evanston, IL (US)

(72) Inventors: John Mark Torkelson, Skokie, IL (US); Yixuan Chen, Evanston, IL (US); Nathan Suryajaya Purwanto, Morton Grove, IL (US); Boran Chen, Evanston, IL (US)

(21) Appl. No.: 19/187,124

(22) Filed: Apr. 23, 2025

Related U.S. Application Data
(60) Provisional application No. 63/639,848, filed on Apr. 29, 2024.

(51) Int. Cl. C08J 9/14; C08G 18/32; C08G 18/38; C08J 9/38

(52) U.S. Cl. CPC C08J 9/149; C08G 18/3234; C08G 18/3855; C08J 9/38; C08J 2203/12; C08J 2375/04

(57) ABSTRACT

Methods of forming a disulfide-crosslinked non-isocyanate polythiourethane (NIPTU) foam are provided, the methods comprising: reacting a difunctional cyclic dithiocarbonate and a diamine in the presence of a blowing agent to form a NIPTU foam having a solid matrix comprising linear non-isocyanate polythiourethane chains crosslinked by interchain disulfide crosslinks, wherein surfaces of the solid matrix define a plurality of pores distributed throughout. The disulfide-crosslinked non-isocyanate polythiourethane (NIPTU) foams formed by the methods are also provided.

### CROSS-REFERENCE TO RELATED APPLICATIONS

The present application claims priority to U.S. provisional patent application No. 63/639,848 that was filed Apr. 29, 2024, the entire contents of which are incorporated herein by reference.

### REFERENCE TO GOVERNMENT RIGHTS

This invention was made with government support under DE-EE 0008928 awarded by the Department of Energy. The government has certain rights in the invention.

### BACKGROUND

Polyurethanes (PU s), traditionally synthesized by reacting isocyanates and alcohols, stand as the sixth most produced class of plastics owing to their versatile properties and outstanding durability. Unlike the other highly produced plastics, such as polyethylene, polypropylene, and poly(ethylene terephthalate) (PET) that are predominantly produced as thermoplastics, the majority of PU plastics are produced as crosslinked thermosets. Notably, crosslinked PU foams, created by leveraging the CO₂-releasing reaction between isocyanate and water, account for ˜60% of PU production and find widespread use in mattresses, cushioning, and insulation materials. (Kausar, A. Polymer-Plastics Technology and Engineering 2018, 57 (4), 346-369.) Recently, the sustainability challenges of PU foams have gained significant academic and industrial traction. First, the increasing regulation of isocyanates stems from concerns about their toxicity towards workers and safety during transportation and storage. Second, the synthesis of isocyanates heavily relies on petroleum-based resources, which conflicts with the growing focus on sustainable polymers. Third, the slow chemistry of urethane exchange reaction presents challenges in reprocessing traditional PU thermosets, leading to the accumulation of PU waste, particularly waste from PU foams.

The sustainability concerns of PU foams have spurred recent research on developing porous non-isocyanate PU (NIPU) materials, largely focused on the class of polyhydroxyurethanes (PHUs) foams. However, low reactivity has been a major roadblock in further adoption of PHU foams, causing extremely long timeframes for synthesizing PHU foams. In addition, PHU foams, especially water-induced self-blowing PHU foams have abundant hydroxyl groups that exhibit a tendency for water absorption. Upon absorbing moisture from the ambient environment, PHU foam materials can suffer detrimental property reduction.

### SUMMARY

Provided are methods for synthesizing reprocessable non-isocyanate polythiourethane (NIPTU) foams. The NIPTU foams and methods of reprocessing the foams are also provided.

The present disclosure is illustrated by reference to an Example, below, that demonstrates the development of a series of reprocessable, re-foamable, biobased, catalyst-free NIPTU foams crosslinked via the auto-oxidation of the pendant thiol groups into disulfides. Capitalizing on the interplay of fast ring-opening of a cyclic thiocarbonate to create linear backbones and slightly slower thiol auto-oxidation to create disulfide crosslinks, the gelling reaction synchronized nicely with the vaporization of a blowing agent used during the synthesis. Different blowing agents were used to achieve facile tunability of morphological and physical properties. In addition, incorporating a small amount of a trifunctional crosslinker significantly enhanced the compressive mechanical properties of the foam. Moreover, the rapid and catalyst-free disulfide dynamic exchange was leveraged to achieve the reprocessability and extrudability of the NIPTU foams. The Example further demonstrates that the foams are intrinsically self-healable and reprocessable via compression molding. Rapid stress relaxation at temperatures above 160° C. was observed, enabling continuous processing techniques like extrusion and pseudo-injection molding. Spent foams were extruded into bulk films at 180° C. with excellent property retention. Additionally, for the first time, foam-to-foam recycling of non-isocyanate polyurethane foams was demonstrated. By adding a small amount of sodium bicarbonate blowing agent into the spent foams prior to extrusion, CO₂ gas was generated during extrusion, leading to a cellular structure. The Example highlights the superior property and sustainability advantages of NIPTU foams: the catalyst-free, rapid synthesis of foams and excellent property tunability, self-healing capability, and amenability towards a family of reprocessing techniques including compression molding, extrusion into bulk films, and foam-to-foam extrusion.

In one aspect, a method of forming a disulfide-crosslinked non-isocyanate polythiourethane (NIPTU) foam is provided, the method comprising: reacting a difunctional cyclic dithiocarbonate and a diamine in the presence of a blowing agent to form a NIPTU foam having a solid matrix comprising linear non-isocyanate polythiourethane chains crosslinked by interchain disulfide crosslinks, wherein surfaces of the solid matrix define a plurality of pores distributed throughout.

In another aspect, a disulfide-crosslinked non-isocyanate polythiourethane (NIPTU) foam is provided having a solid matrix comprising linear non-isocyanate polythiourethane chains crosslinked by interchain disulfide crosslinks, wherein surfaces of the solid matrix define a plurality of pores distributed throughout, and further wherein the linear non-isocyanate polythiourethane chains are the reaction product of difunctional cyclic dithiocarbonate monomers and diamine monomers.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIG. 1 schematically illustrates that a NIPTU foam that is crosslinked with dynamic disulfide bonds can undergo foam-to-film recycling by compression molding. In turn, that leads to a reprocessable film, foam-to-film recycling by extrusion/injection molding, refoaming by extrusion/injection molding, and self-healing.

FIG. 2A shows a synthesis scheme of an illustrative NIPTU foam (NIPTUF (Cyclo, 1074, Ac)) synthesized from difunctional DTC, Cyclo-DTC, and a difunctional amine, Priamine-1074, resulting in a NIPTU foam with linear polymer chain backbones and crosslinked with disulfide bonds from thiol auto-oxidation. FIG. 2B further illustrates the synthesis procedure of the NIPTU foam (NIPTUF (Cyclo, 1074, Ac)) including a 15 min reaction, during which the rates of foaming (bubble nucleation) and gelling (thiol auto-oxidation) are in a proper balance.

FIGS. 3A-3B show pictures and FIG. 3C shows SEM images of a virgin NIPTU foam. FIG. 3D shows a compressive stress-strain curve of the virgin NIPTU foam. All NIPTU foam samples in this figure are NIPTUF (Cyclo, 1074, Ac).

FIG. 4A shows stress relaxation curves of an NIPTU foam as a function of temperature. FIG. 4B shows an apparent Arrhenius plot of the NIPTU foam derived from average stress relaxation time. FIG. 4C shows hot compression molding foam-to-film recycling of the NIPTU foam at different temperatures. FIG. 4D shows DMA E′ and tan δ curves of the virgin foam, a 1^{st} mold Comp-film from 180° C. and 3 min recycling, and a 2^{nd} mold Comp-film obtained under the same condition. FIGS. 4E-4F show the proof-of-principle self-healing test of virgin NIPTU foam. All NIPTU foam samples in this figure are NIPTUF (Cyclo, 1074, A c).

FIG. 5A illustrates the foam-to-film recycling of a NIPTU foam using a twin-screw extruder in free extrusion direction, leading to an Ext-film. FIG. 5B shows foam-to-film recycling of a NIPTU foam using a twin-screw extruder in backflow direction with a mold cavity emulating injection molding, leading to an Inj-film. FIG. 5C shows DMA E′ and tan δ curves of the Ext-film and the Inj-film in comparison with the virgin foam and the 1^{st} mold Comp-film. All NIPTU foam samples in this figure are NIPTUF (Cyclo, 1074, Ac).

FIG. 6A illustrates foam-to-foam recycling, or refoaming, schematics for a NIPTU foam. FIGS. 6B-6D show a picture and SEM images of a refoamed sample. FIG. 6E shows a DM A storage modulus and tan § curves of a refoamed sample in comparison with the virgin foam. FIG. 6F shows a stress-strain curve of a refoamed sample from compression test. All NIPTU foam samples in this figure are NIPTUF (Cyclo, 1074, Ac).

FIG. 7 shows the synthesis, images, and SEM micrographs of another illustrative NIPTU foam (Cyclo, 1074, EA).

FIG. 8 shows the synthesis, images, and SEM micrographs of another illustrative NIPTU foam (NC-514/GTTC, 1074, EA).

### DETAILED DESCRIPTION

Reprocessable (i.e., recyclable) non-isocyanate polythiourethane (NIPTU) foams are provided. Catalyst-free methods of making and reprocessing the foams are also provided. During synthesis, NIPTU polymer chains are formed and crosslinked in the presence of a blowing agent via the auto-oxidation of pendant thiol groups in a gelling reaction. The resulting foams have disulfide crosslinks (i.e., —SS—) between individual NIPTU polymer chains (and/or portions thereof). The NIPTU polymer chains comprise thionurethane groups having the structure:

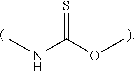

During foam formation, the gelling and foaming reactions are balanced because the rate of auto-oxidation is sufficiently slow relative to the foaming reaction to allow foaming to occur prior to complete gelation of the NIPTU polymer chains. The resulting foams have excellent property tunabilities, self-healing capabilities, and can be reprocessed using a variety of techniques, including compression molding, extrusion, and injection molding, as well as foam-to-foam extrusion.

The synthesis of the NIPTU polymer network of the NIPTU foams involves the aminolysis of a cyclic dithiocarbonate (DTC) using a diamine, both of which may be provided in a foaming formulation. The resulting NIPTU polymer chains have pendant thiol groups (i.e., —SH groups, e.g., —CH₂SH groups) that undergo auto-oxidation to form disulfide bonds that crosslink individual NIPTU polymer chains (and/or portions thereof) together to form the NIPTU polymer network. The disulfide crosslinks may be referred to herein as interchain crosslinks. These disulfide crosslinks, which can undergo rapid and catalyst-free disulfide dynamic exchange reactions, render the foams intrinsically self-healable and reprocessable via compression molding, extrusion, or injection molding.

The synthesis methods take advantage of the interplay of the fast ring-opening of the cyclic dithiocarbonates to create linear NIPTU polymer chains and the slower thiol auto-oxidation to create the disulfide crosslinks. By including a blowing agent in the foaming formulation, the gelling reaction can be synchronized with the vaporization of the blowing agent to provide tunability of the morphological and physical properties of the foam. This synchronization is crucial for the formation of an NIPTU foam because the foaming of the foaming formulation must take place while the strength of the NIPTU polymer network is sufficiently high to prevent bubble collapse, yet not so high as to suppress bubble nucleation. If the gelling reaction is too fast, it rapidly leads to the formation of an excessively strong NIPTU polymer network that suppresses bubble nucleation and fails to provide a foam.

To address the significant challenges in forming NIPTU foams, the present methods take advantage of the gradual auto-oxidation of the thiol groups along the NIPTU polymer chains to form the interchain disulfide crosslinks at mild temperatures and without the need to add any external catalyst that promotes any of the network-forming reactions (i.e., the cyclic dithiocarbonate-diamine reactions and the thiol group auto-oxidation reactions). The methods employ only, or predominantly, difunctional cyclic dithiocarbonate and diamine monomers to produce NIPTU polymer chains composed solely, or predominantly, of linear NIPTU polymer chains bearing the pendant thiol groups. In this way, the NIPTU polymer network formation is slower than if trifunctional (or higher functional) cyclic dithiocarbonate and/or trifunctional (or higher functional) amines were used, because crosslink formation during the gelling reaction depends only, or predominantly, on the relatively slow formation of disulfide bonds via thiol auto-oxidation. The relatively slow gelling reaction in the present methods enables foaming to take place before the NIPTU polymer network strength suppresses bubble formation.

As noted above, the foaming formulation comprises a difunctional cyclic DTC and a difunctional amine (which may be referred to as a diamine). This means that the difunctional cyclic DTC has only two dithiocarbonate moieties and the difunctional amine has only two amine moieties. Regarding the difunctional cyclic DTCs, suitable compounds include those having two cyclic 5-membered dithiocarbonate groups connected by an ether group. Such compounds may be characterized by the following structure:

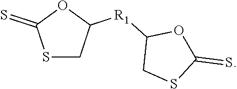

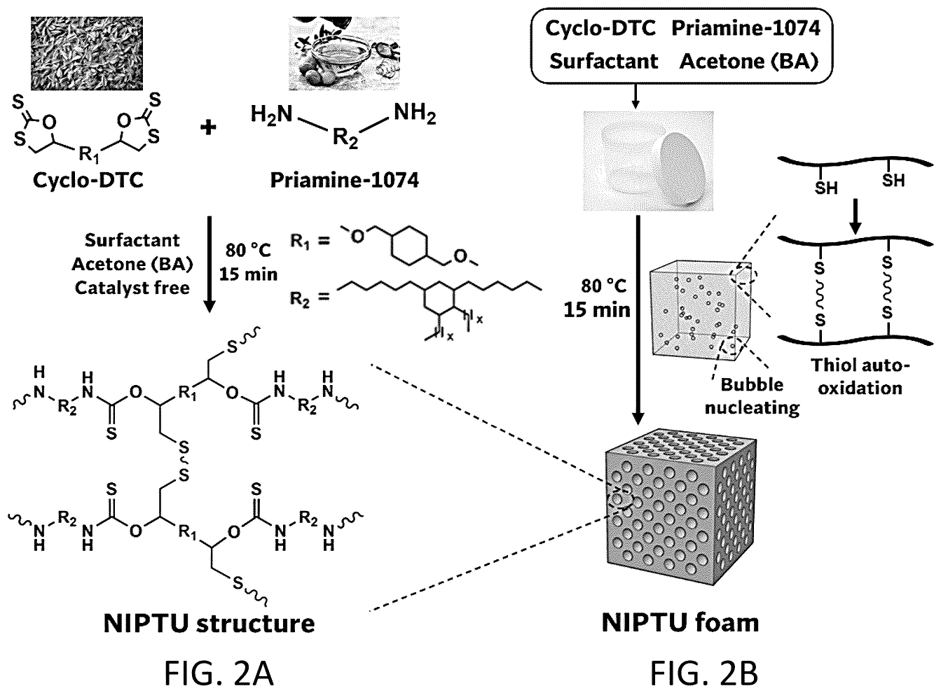

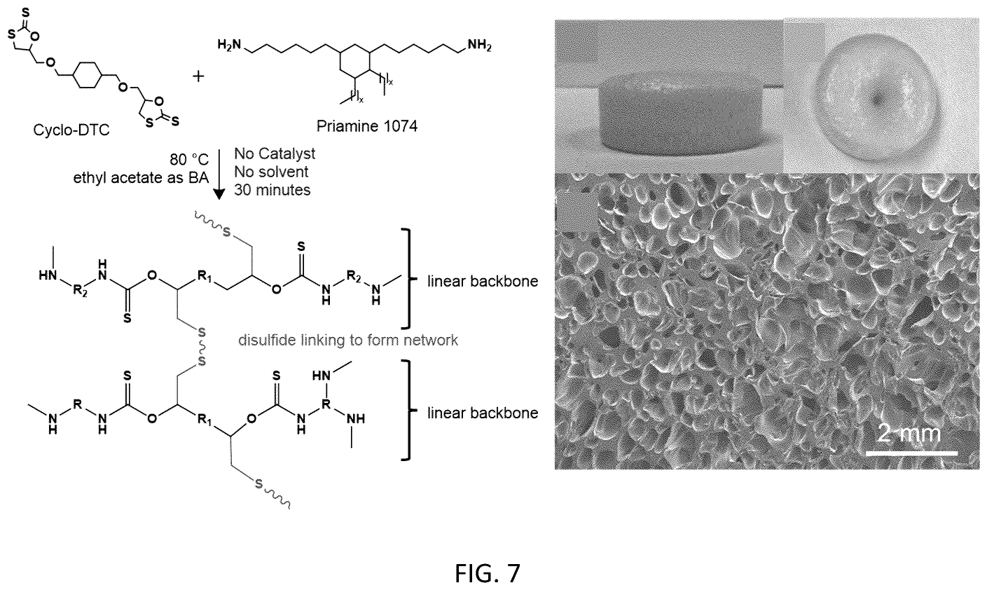

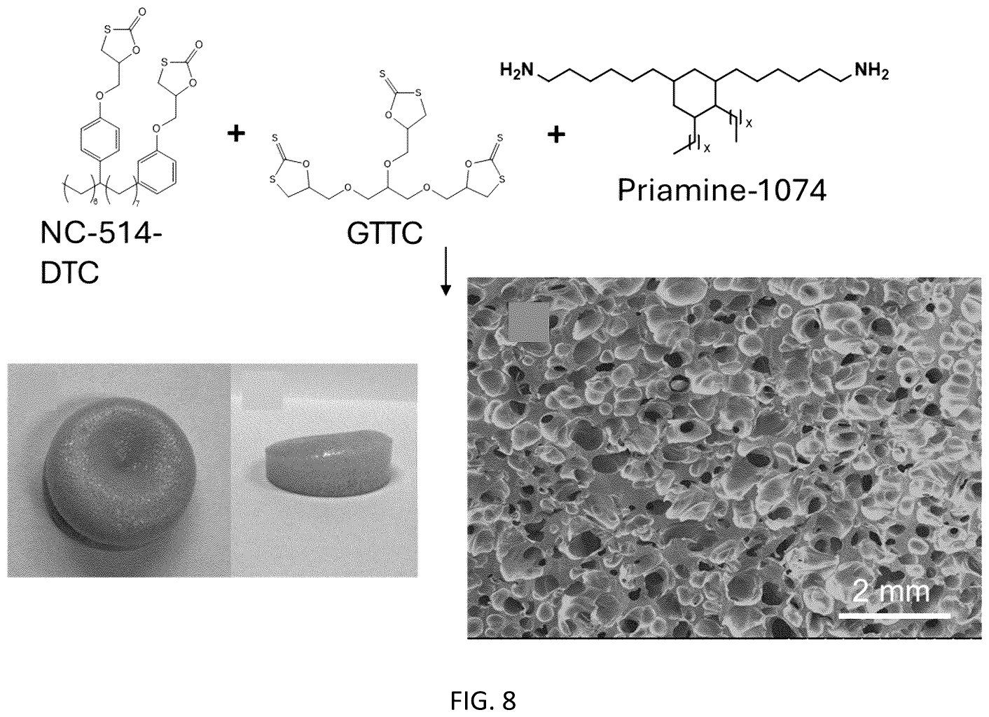

In this formula, R₁ is an ether group. The ether group may be an aliphatic ether group in which an aliphatic group is bonded within the ether group. The aliphatic group may be linear, branched, or cyclic and the carbon-carbon bonds therein may be saturated or unsaturated. Unsubstituted aliphatic ether groups may be used which refers to aliphatic ether groups that do not contain heteroatoms (other than oxygen). The ether group may be an aromatic ether group in which an aromatic group is bonded within the ether group. The aromatic group may be a monocyclic aromatic group (e.g., phenyl). Unsubstituted aromatic ether groups may be used which have a meaning analogous to unsubstituted aliphatic ether groups, but also encompass aromatic groups having aliphatic substituents. More than one aliphatic (or aromatic) group and/or more than one oxygen may be present in R₁ such that the ether group is a polyether group. The difunctional cyclic DTC may be one derived from a natural product. For example, Cyclo-DTC is a difunctional cyclic DTC that can be derived from rice husks. NC-514-DTC is another difunctional cyclic DTC that can be derived from cashew nutshell liquid. The structure of Cyclo-DTC is shown in FIGS. 2A and 7 and the structure NC-514-DTC is shown in FIG. 8. Thus, in embodiments, R₁ is selected from:

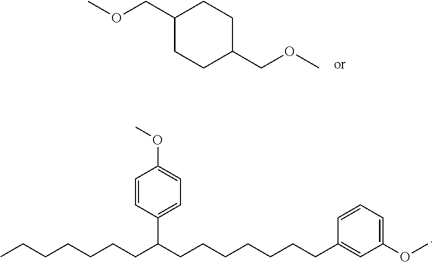

In such embodiments, the NIPTU polymer network of the foam comprises such R₁ groups. Other suitable cyclic DTCs that can be used include, 1,3-butadiene-DTC, 1,4-butanediol-DTC, divinylbenzene-DTC, resorcinol-DTC, soybean oil-based DTC, vegetable oil-based DTC, poly(propylene glycol) (PPG) and poly(tetramethylene glycol) (PTMEG) end-capped with DTC units, and bisphenol A DTC.

Regarding the diamines of the foaming formulation, compounds having the following structure may be used: H₂N—R₂—NH₂, wherein R₂ is an aliphatic group or an aromatic group. The aliphatic group may be linear, branched, or cyclic and the carbon-carbon bonds therein may be saturated or unsaturated. Unsubstituted aliphatic ether groups may be used which refers to aliphatic ether groups that do not contain heteroatoms. The aromatic group may be a monocyclic aromatic group (e.g., phenyl). Unsubstituted aromatic ether groups may be used which have a meaning analogous to unsubstituted aliphatic ether groups, but also encompass aromatic groups having aliphatic substituents. A difunctional amine that may be used is Priamine 1074, the structure of which is shown in FIGS. 2A and 7. Thus, in embodiments, R₂ is

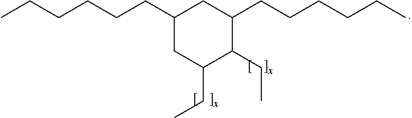

In such embodiments, the NIPTU polymer network of the NIPTU foam comprises such R₂ groups. Another suitable diamine that may be used is m-xylylene diamine (mXDA). Polyether diamines may also be used, in which R₂ is an aliphatic ether group as described above. Such polyether diamines are commercially available under the tradename Jeffamine, including Jeffamine® EDR-148, Jeffamine D-230, and Jeffamine D-400. The R₂ group may be an aliphatic methylene group, e.g., diamines such as 2-methylpentamethylenediamine (available under the tradename Dytek® A), hexamethylene diamine, 1,10-diaminodecane, and methylenebis(2-methylcyclohexylamine) may be used.

The foaming formulation further comprises a blowing agent. The blowing agent may be a physical blowing agent, a volatile compound that changes into a gas (volatilizes) or decomposes to form a gas during gelation. This results in the formation of cells (pores) in the NIPTU polymer network, thereby creating the cellular structure (i.e., foam). The physical blowing agents do not undergo chemical reactions with the monomers (e.g., cyclic DTC, diamine) that form the NIPTU polymer network. Examples of physical blowing agents include acetone and alkyl alkanoates, such as ethyl acetate. Other examples of blowing agents include bicarbonates and supercritical carbon dioxide, as well as hydrocarbons, such as pentane, isopentane, and hexane.

The type and amount of the monomers and the type and amount of the blowing agent in the foaming formulation may be selected depending upon the desired properties for the NIPTU foam. As demonstrated in Example 1, below, the monomers generally have a relatively greater effect on foam mechanical properties and T_{g} and while the blowing agent generally has a relatively greater effect on foam morphology. For example, lower density foams having larger cell sizes (d_{cell}) generally correspond to blowing agents having a lower boiling point or decomposition temperature. At the NIPTU polymer network-forming reaction temperature, the foaming formulation is at or above the boiling point or decomposition temperature of the blowing agent being used. For relatively low boiling point blowing agents, vaporization is vigorous and fast, resulting in large cells and lower density, while vaporization of higher boiling point blowing agents is slower, allowing more disulfide crosslinks to form and increasing the viscosity during foaming, resulting in smaller cell sizes and higher density. Illustrative blowing agents have been provided above, but regarding boiling points, the boiling point of the selected blowing agent may be in a range of from 40° C. to 90° C., from 50° C. to 80° C., or from 55° C. to 75° C. Illustrative amounts of the blowing agent include from 2 weight % to 10 weight %, from 3 weight % to 9 weight %, and from 4 weight % to 8 weight % (all as compared to total weight of the monomers). Illustrative monomers have been provided above, but regarding amounts, generally a stoichiometric amount of the dithiocarbonate monomer to the amine monomer is used.

When the NIPTU foams are formed from only difunctional monomer reactants, the foams have only linear NIPTU polymer chains crosslinked solely with the interchain disulfide bonds. This may be confirmed using FTIR and swelling tests as described in the Example, below. Such embodiments may be characterized as being free of branched NIPTU polymer chains and the NIPTU polymer network may be described as being a crosslinked linear network rather than a crosslinked branched network. Such embodiments may also be characterized as being free of crosslinks other than the interchain disulfide crosslinks.

However, in embodiments, it is possible to include a small quantity of tri- or higher functional (for example, tetra-functional) thiocarbonates and/or tri- or higher functional amine monomers to increase the compressive mechanical properties of the NIPTU foam by increasing the crosslink density by introducing thiourethane crosslinks. However, the amount of these tri- and higher-functional reactants should be limited to maintain a low rate of NIPTU polymer network formation and enable the foaming reaction to proceed as described above. Thus, when tri- or higher functional reactants are used, the reactants are still predominantly difunctional. By way of illustration, the amount of tri- and higher-functional reactants (e.g., thiocarbonates) should be limited to less than 50 mol. % to maintain a majority of disulfide crosslinks and prevent pre-percolation in the foam. This includes less than 45 mol. % and less than 40 mol. %. These mol. % are calculated as follows: for thiocarbonate reactants mol. %=(total moles of higher functional thiocarbonate functional group originating from higher functional thiocarbonate monomer)/(total moles of thiocarbonate functional group)*100; for amine reactants mol. %=(total moles of higher functional amine reactants)/(total moles of amine reactants)*100. As such, the amount of the difunctional reactants (e.g., difunctional cyclic dithiocarbonate) in the foaming formulation should be at least 50 mol. % of any corresponding higher functional reactant that is included. This includes at least 55 mol. %, at least 60 mol. %, at least 65 mol. %, at least 70 mol. %, at least 75 mol. %, at least 80 mol. %, at least 85 mol. %, at least 90 mol. %, at least 95 mol. %, or 100 mol. %.

Trifunctional dithiocarbonates having three cyclic dithiocarbonate groups, such as glycerol tri(cyclic thiocarbonate) (GTTC as shown in FIG. 8), trimethylolpropane tri(cyclic thiocarbonate), tris(4-hydroxyphenyl)methane tri(cyclic thiocarbonate), any vegetable-derived tri(cyclic thiocarbonate), and thiocarbonated epoxy novolac resins are examples of higher functionality cyclic dithiocarbonates that can be added to the foaming formulation in small quantities. Regarding GTTC, use of this compound as a monomer leads to the inclusion of crosslinks in the NIPTU polymer network of the foam having the structure:

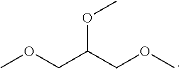

Although not shown in the structure, the resulting crosslinks further include thionurethane groups and thus, may be referred to as thionurethane crosslinks. In such embodiments, the NIPTU polymer network of the foam comprises such thionurethane crosslinks.

Regarding tri- or higher functional amine monomers, poly(alkylene glycol) polyamines, including poly(propylene glycol) (PPG) polyamines and poly(ethylene glycol) (PEG) polyamines are examples. Branched poly(alkylene glycol) polyamines are characterized by a branched poly(alkylene glycol) core functionalized with three or more amine groups, which are typically at the ends of the poly(alkylene glycol) chains. Jeffamine T-403 is an example of a branched poly(alkylene glycol) polyamine.

Other components may be included in the foaming formulations, e.g., a surfactant. Illustrative surfactants are provided in Example 1, below. Illustrative amounts of the surfactant include from 3 weight % to 10 weight %, from 4 weight % to 9 weight %, and from 5 weight % to 8 weight % (all as compared to total weight of monomers).

As noted above, no catalysts are required for synthesizing the NIPTU foam, nor are they required for reprocessing. Thus, the foaming formulations (and the NIPTU foams) may be free of any catalyst that would otherwise catalyze the gelling reactions (NIPTU polymer chain formation via aminolysis and disulfide crosslinking via oxidation). The foaming formulations (and the NIPTU foams) may also be free of any oxidizing agent (including in its reduced form) that would otherwise promote the formation of the disulfide crosslinks. Oxidizing agents that may be excluded include metal oxides, such as MnO₂, PbO₂, KMnO₄, ZnCrO₄, Na₂Cr₂O₇, CaO₂, BaO₂, Na₂O₂, and Na₂B₂O₄(OH)₄, and organic oxidizing agents, such as p-benzoquinone dioxime, cumene, and hydroperoxide.

Even in the absence of aminolysis catalysts and oxidizing agents, the formation of the NIPTU polymer network, including formation of the disulfide crosslinks, can go to completion using the present methods. This includes a disulfide crosslinked NIPTU polymer network in which the polythiourethane backbone is free of unreacted pendant thiol groups. The absence of unreacted pendant thiol groups can be confirmed via FTIR, whereby the FTIR spectrum of a polythiourethane backbone that is free of unreacted pendant thiol groups will be free of peaks corresponding the —SH groups. In recognition of the inherent nature of chemical synthesis, a very small number of unreacted thiol groups may be present after network formation (e.g., 5% or less, 4% or less, 3% or less) and the network may still be considered to be free of unreacted pendant thiol groups. Similarly, even without any aminolysis catalysts, the disulfide crosslinked NIPTU polymer network may be synthesized such that it is free of unreacted monomers (e.g., unreacted cyclic dithiocarbonates and unreacted diamines). FTIR may also be used to confirm that the polymerization reactions have gone to completion. In recognition of the inherent nature of chemical synthesis, a very small number of unreacted monomers may be present after network formation (e.g., 5% or less, 4% or less, 3% or less) and the network may still be considered to be free of unreacted monomers.

The foaming formulations may consist of any of the disclosed difunctional cyclic DTCs, any of the disclosed difunctional amines, any of the disclosed blowing agents, any of the disclosed surfactants, and optionally, any of the disclosed higher functional monomers (e.g., trifunctional cyclic dithiocarbonates). In embodiments, the foaming formulations consist of any of the disclosed difunctional cyclic DTCs, any of the disclosed difunctional amines, any of the disclosed blowing agents, and any of the disclosed surfactants.

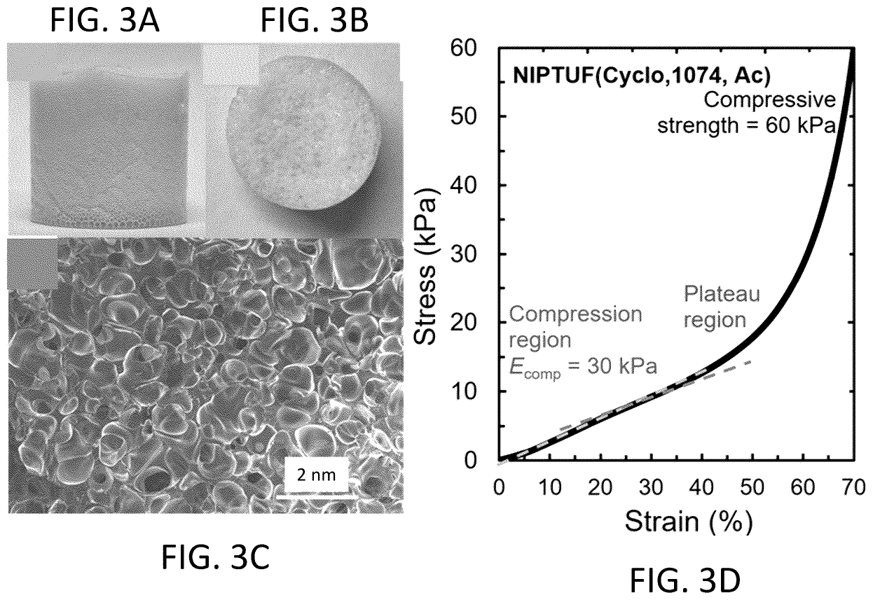

Further regarding NIPTU foam morphology, the structure is a solid NIPTU polymer matrix, the surfaces of which define a plurality of cells (pores) distributed throughout. Illustrative foams are shown in the SEM images FIGS. 3A-3C, 7, and 8. These images show that the cells of the foams are generally spherical (circular cross-sections) and uniformly distributed throughout the solid NIPTU polymer matrix. The foams may be characterized by their density, average cell diameter (d_{cell}), and degree of open-cell morphology (Aₕ/A_{c}), each of which may be measured as described in Example 1, below. The foams may be characterized by other properties such as compressive modulus (E_{comp}), compressive strength (s_{65%}), and glass transition temperature (T_{g}), each of which may be measured as described in Example 1, below. Tunability of these parameters may be achieved as described above, including by appropriate selection of type and amount of the monomers and blowing agent. However, foam density may be in a range of from 0.05 to 0.50 gcm⁻³, 0.08 to 0.40 gcm⁻³, and 0.10 to 0.30 gcm⁻³; d_{cell} may be in a range of from 0.10 to 0.70 mm, 0.20 to 0.60 mm, and 0.30 to 0.50 mm; and Aₕ/A_{c} may be in a range of from 0.040 to 0.20, from 0.050 to 0.15, and from 0.060 to 0.10. The E_{comp} and s_{65%} values may be those that classify the foam as a semi-rigid foam or a flexible foam. Similarly, the T_{g} may be from 6 to 12° C. or from 17 to 25° C.

The present synthesis methods are “one-pot” methods comprising combining the monomers (e.g., the difunctional cyclic DTC and the diamine) along with the blowing agent, and, optionally, the surfactant. These components are then mixed and heated to a reaction temperature that is above the vaporization temperature of the blowing agent and sufficient to induce aminolysis and thiol oxidation, but typically below 100° C. The reaction temperature may be, for example, in the range from about 70° C. to about 90° C. The reaction is allowed to proceed until gelation (NIT PU polymer chain formation and disulfide crosslinking) is complete. The reaction time may be, e.g., from 10 min to 1 hour, including from 20 min to 50 min, and from 30 min to 1 hr.

The disulfide crosslinks in the NIPTU polymer networks are dynamic at elevated temperatures. That is, they undergo disulfide bond breaking and reforming (exchange) reactions when heated above room temperature (about 23° C.). Typically, the disulfide bonds are dynamic at temperatures of 120° C. or greater, including temperatures of 130° C. or greater and temperatures of 140° C. or greater (e.g., temperatures in the range of between any of these values, including from 120° C. to 200° C. or from 120° C. to 180° C.). The fast dynamic chemistry of the interchain crosslinks in the NIPTU foams render them reprocessable using techniques that include foam-to-film recycling and/or foam-to-foam recycling. In addition, the foams are capable of self-healing.

The basic method of reprocessing the NIPTU foams includes the steps of: heating one or more pieces (or particles) of a NIPTU foam (i.e., a porous disulfide crosslinked non-isocyanate polythiourethane network) from a first temperature to a second temperature, wherein dynamic disulfide exchange (reversible disulfide dissociation) occurs to a greater extent at the second temperature than at the first temperature; reshaping the one or more pieces (or particles) of the NIPTU foam at the second temperature to form a reshaped disulfide crosslinked non-isocyanate polythiourethane network; and cooling the reshaped disulfide crosslinked non-isocyanate polythiourethane network to form a reprocessed disulfide crosslinked non-isocyanate polythiourethane network. As further described below, in embodiments, this reshaped disulfide crosslinked non-isocyanate polythiourethane network is a non-porous object (e.g., a film as in foam-to-film reprocessing), but in other embodiments, this reshaped disulfide crosslinked non-isocyanate polythiourethane network is also porous and thus, may be considered to be a refoamed object (e.g., as in foam-to-foam reprocessing). The first temperature in the reprocessing method may be room temperature while the second temperature may be as described above with respect to the disulfide crosslink exchange reactions, e.g., from 120° C. to 200° C.

The reprocessing can be carried out using, for example, extrusion or injection molding. This is advantageous because these are widely utilized commercial methods for processing polymers, with extrusion enabling continuous processing and injection molding allowing for the production of objects in designated shapes. However, compression molding may also be used. Each of these techniques can be conducted rapidly, at relatively mild temperatures, and without the additional of any catalysts as described above. Notably, after one or more cycles (1, 2, 3, etc.) of reprocessing, the NIPTU polymer networks are able to recover their crosslink density, as demonstrated in Example 1. A single reprocessing cycle refers to a single round of heating, reshaping, and cooling. The reprocessing of the NIPTU foams into a non-porous object (e.g., film) or into a refoamed object may be carried out in a time of 20 minutes or less, including times in the range from 2 minutes to 15 minutes, or from 3 minutes to 10 minutes. However, times outside of these ranges can be used. These times refer to the time of a single reprocessing cycle.

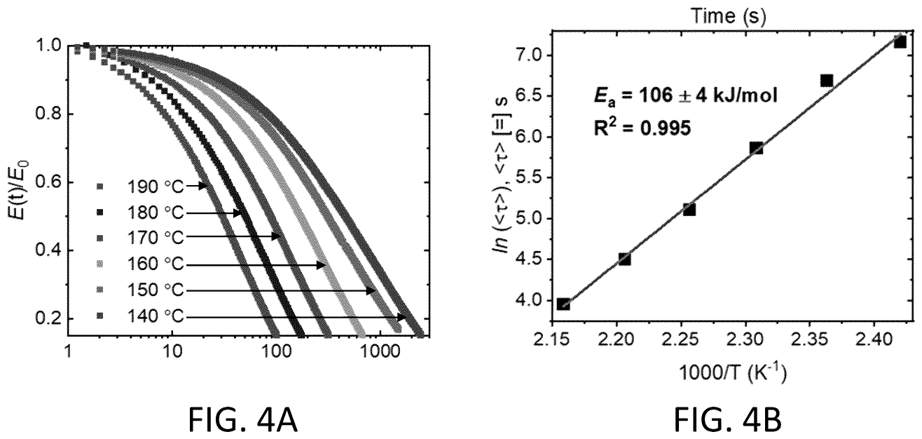

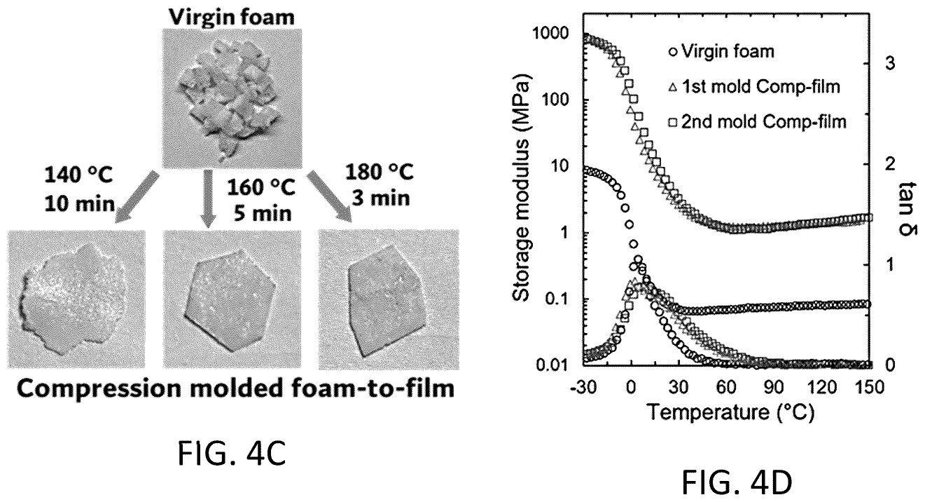

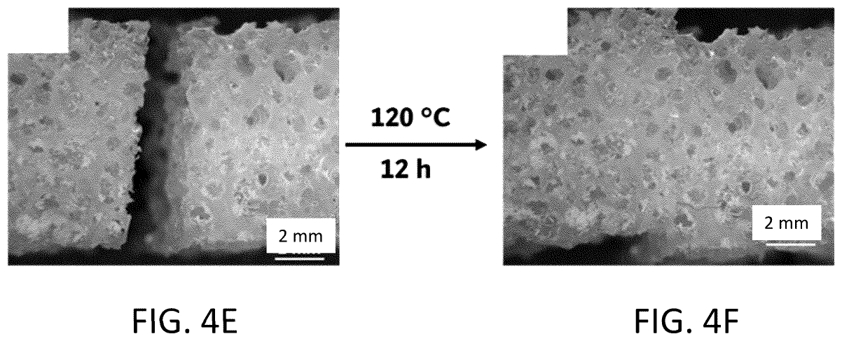

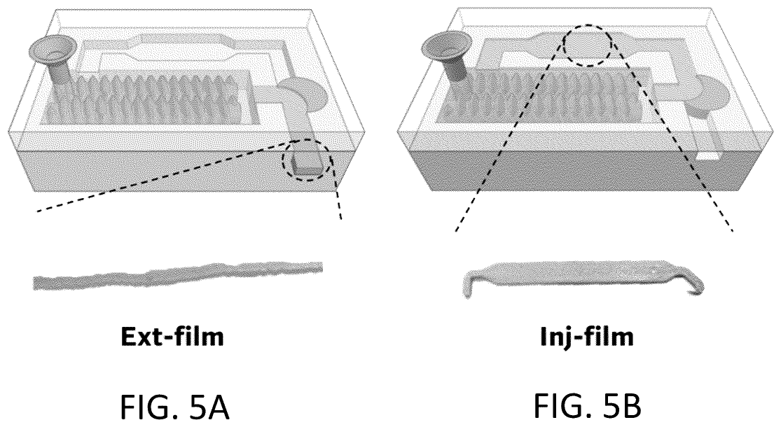

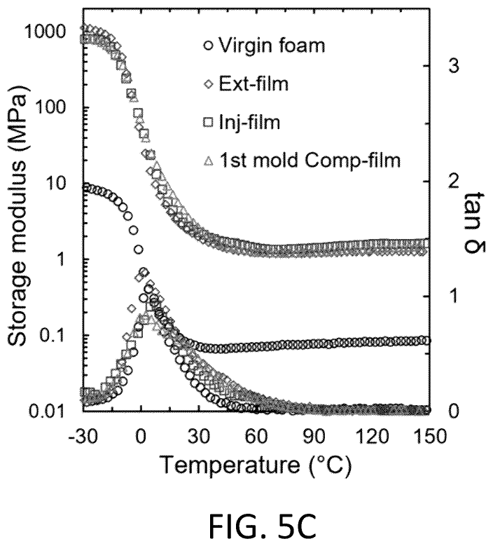

Regarding crosslink density, this may be measured using dynamic mechanical analysis as described in Example 1, below. For NIPTU foams reprocessed into non-porous objects such as films, recovery of crosslink density refers to the non-porous object after the n^{th} cycle (e.g., 2^{nd}) having a measured E′ that is at least 85% of the measured E′ of the non-porous object after the 1^{st} cycle. This includes at least 90%, at least 95%, and at least 98%. (See Table 3 and FIGS. 4D, 5C.) The E′ values of the non-porous objects will be larger than that of the original foams from which they are derived, which also confirms that the reprocessing eliminates the cellular (porous) structure. Elimination of pores may also be confirmed using SEM.

### Foam-to-Film Reprocessing (Recycling).

NIPTU foam-to-film recycling can be accomplished using hot compression molding, whereby heat and force are applied using a compression molder to eliminate the porous cellular structure and to facilitate dynamic disulfide bond breaking and reformation, followed by cooling to recover the crosslink density in the resulting non-porous NIPTU film. Alternatively, NIPTU foam-to-film recycling can be carried out using melt-state free extrusion (FIG. 5A) or “pseudo-injection molding” (FIG. 5B) using an extruder, whereby NIPTU foam pieces are fed into an extruder in which they are heated and rotated and extruded. During the extrusion, the porous cellular foam structure is eliminated and dynamic disulfide bond breaking, exchange, and reformation occurs. Upon cooling of the extrudate, the crosslink density in the resulting non-porous NIPTU film is recovered as described above. The extrusion may be a free-extrusion or an injection molding extrusion in which the extrudate undergoes injection molding. Thus, the term “film” also encompasses non-porous objects having non-planar shapes, including complex three-dimensional shapes depending upon the mold used. Illustrative reprocessing temperatures and times have been described above.

### Foam-to-Foam Reprocessing (Recycling).

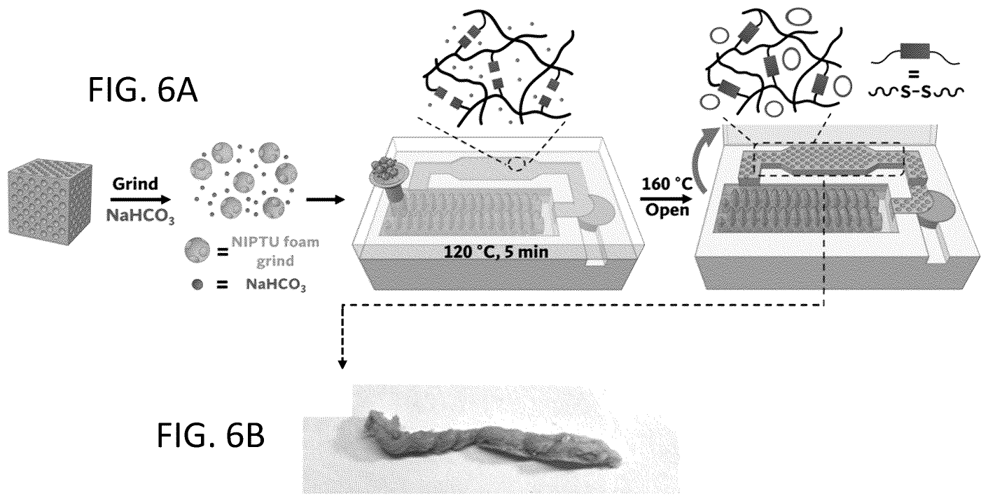

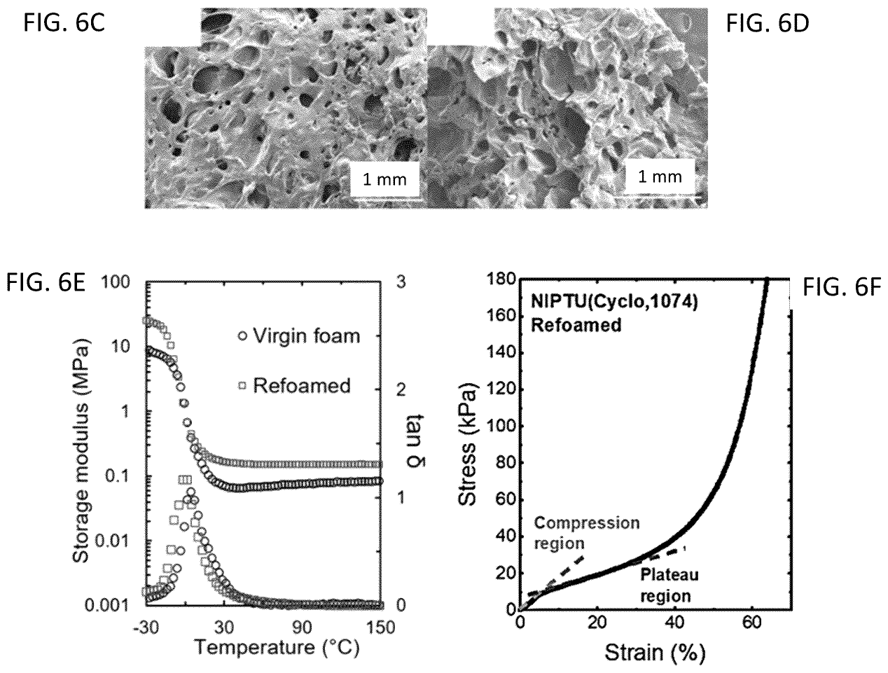

Foam-to-foam recycling (refoaming) can be carried out using the application of heat and pressure with the aid of a blowing agent. In some embodiments, refoaming may be conducted in an extruder. (See FIG. 6A.) As in foam-to-film extrusion, NIPTU foam pieces are fed into the extruder in which they are heated and rotated and extruded. However, during foam-to-foam extrusion, a blowing agent is added to generate pores throughout the NIPTU extrudate. The extrusion may be a free-extrusion or an injection molding extrusion in which the extrudate undergoes injection molding. Illustrative reprocessing temperatures and times have been described above.

During the refoaming, the blowing agent is used to produce gas bubbles that generate the pores throughout the NIPTU extrudate. The blowing agent should be selected such that it generates a gas at the temperature being used during the extrusion or a lower temperature. For example, blowing agents that decompose to generate a gas such as CO₂ gas may be used. One such blowing agent is a bicarbonate, such as sodium bicarbonate (NaHCO₃). Other suitable blowing agents include azodicarbonamide (ADC), supercritical CO₂, hydrocarbons, such as pentane, and carboxymethylcellulose-based blowing agents. The type and amount of blowing agent may be selected based on the desired properties for the refoamed object.

The foam-to-foam reprocessing may be conducted using multiple temperature steps. For example, initially, the blowing agent may be mixed with the NIPTU foam pieces at a temperature that may be above room temperature but below the vaporization/decomposition temperature of the blowing agent to disperse the blowing agent. The temperature can then be increased to induce blowing agent vaporization/decomposition and gas release and dynamic disulfide bond exchange. The gas will dissolve within the polymer at the high pressures being used within the extruder. Rapidly decreasing the pressure (e.g., by opening the lid of the extruder) triggers bubble nucleation and volumetric expansion of the extrudate, while lowering the temperature results in the reformation of disulfide crosslinks, leading to the restoration of the crosslinked NIPTU polymer network and the trapping of the gas bubbles without cell collapse.

### Foam Self-Healing.

NIPTU foams can be self-healed by contacting two or more pieces of the foam at an interface, holding the pieces together at the interface (with or without any force) at an elevated temperature at which dynamic disulfide bond exchange occurs, followed by lowering the temperature to reattach the pieces by reforming the disulfide crosslinks in the interface region. The self-healing can be carried out at relatively mild temperatures in relatively short times. By way of illustration only, temperatures in the range from about 110° C. to 140° C. and times in the range from about 8 hours to 15 hour can be used.

### EXAMPLES

### Example 1

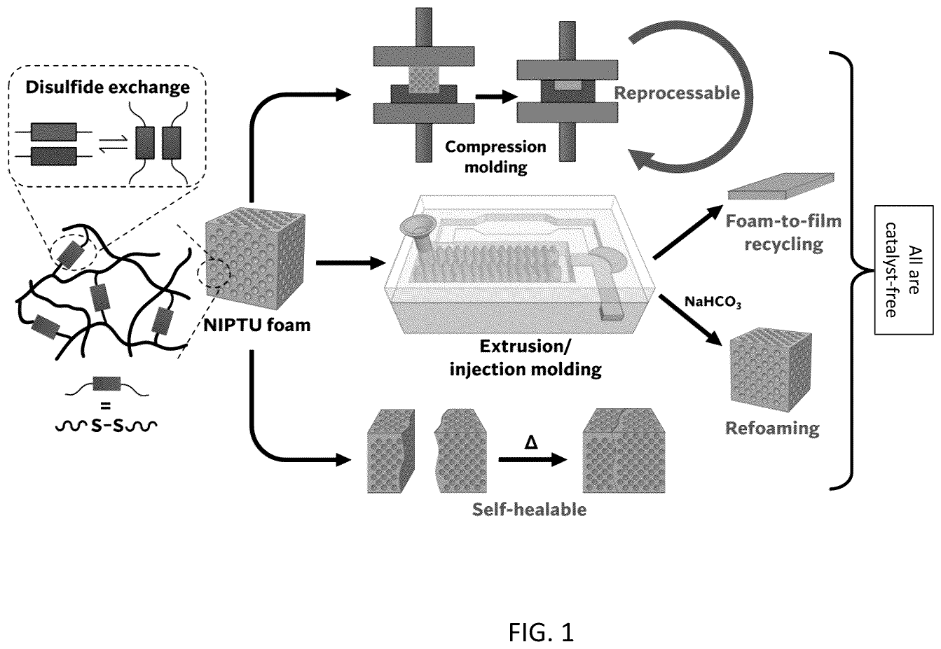

This Example illustrates the fabrication of NIPTU foams that are bioderivable, rapidly synthesized, catalyst-free, and highly recyclable substitutes for traditional PU foams. Two of the three NIPTU foams were derived from biobased difunctional DTCs and difunctional amines, and they featured linear backbones that were crosslinked solely with inter-chain disulfide bonds from the auto-oxidation of pendant thiol groups on the NIPTU backbones. In another case, to demonstrate facile property tunability, a small amount of trifunctional DTC was incorporated to generate further crosslinks and increase associated mechanical properties. Capitalizing on the interplay of fast ring-opening of DTC to create backbones and the slightly slower thiol auto-oxidation to create crosslinks, the gelling time was synchronized with the vaporization of the physical blowing agent (BA). NIPTU foams with homogenous cell morphology were achieved via a fast (˜25 min), one-pot synthesis at relatively mild temperatures (80° C.), in a catalyst-free condition. The NIPTU foams exhibited outstanding mechanical properties that fall into the application of flexible and semi-rigid foams. Exploiting the highly dynamic nature of disulfide crosslinks, the NIPTU foams showed compatibility with various recycling methods and showcased proof-of-principle self-healing capabilities (FIG. 1). Through hot compression molding, foam-to-film recycling could be accomplished within 3-10 min, yielding solid film samples that were further reprocessable with full recovery of crosslink density. Foam-to-film recycling was also achieved by melt-state free extrusion or pseudo-injection molding using a twin-screw extruder. Most importantly, with the aid of sodium bicarbonate as a blowing agent, a successful foam-to-foam recycling (or re-foaming) of the NIPTU foam was demonstrated. Owing to the unique disulfide-crosslinked structure of the NIPTU foams, there was no need for catalysts to achieve any of these recycling approaches.

Additional information, including data indicated as being not shown, may be found in U.S. provisional patent application No. 63/639,848, filed Apr. 29, 2024, the entire contents of which are incorporated herein by reference.

### Materials and Methods

Materials. Priamine™ 1074 was kindly provided by Croda Coatings & Polymers. Glycerol triglycidyl ether [referred to as GE, epoxy equivalent weight (EEW) ˜149 g/eq] was synthesized by Biosynth International, Inc at the inventors' request and was purchased from them. Epoxy ERISYS GE-22 [1,4-cyclohexanedimethanol diglycidyl ether, referred to as Cyclo, epoxy equivalent weight (EEW)=145-165 g/eq], was generously supplied by CVC thermoset specialist. Biobased epoxy Cardolite NC-514 (referred to as NC-514, EEW=350-500 g/eq) was kindly sponsored by Cardolite Corporation. Surfactant Tegomer® E-Si 2330 was kindly supplied by Evonik. Magnesium sulfate (MgSO₄, anhydrous, 99.5%), acetone (ACS reagent, ≥99.5%), lithium bromide (LiBr, ≥99%), chloroform-d (CDCl₃, 99.8% atom D), ethyl acetate (EtOAc or EA, ACS grade), sodium chloride (NaCl, ACS, 99%), sodium bicarbonate (NaHCO₃, ACS, 99%), 1,2,4,5-tetrachlorobenzene (TCB), carbon disulfide (CS₂, anhydrous, ≥99%), tri-n-butylphosphine (97%), and tetrahydrofuran (THF, ≥99.9%) were obtained from Sigma Aldrich.

Determination of Epoxy Equivalent weight (EEW). The epoxy equivalent weights (EEW) of Cyclo, NC-514, and GTE were determined via 1H NMR spectroscopy using 1,2,4,5-tetrachlorobenzene as the internal standard. The EEW values of Cyclo, NC-514, and GTE were determined as 157 g/mol, 472 g/mol, and 149 g/mol, respectively. Data is not shown for H¹ NMR and C¹³ NMR information of Cyclo, NC-514, and GE.

Synthesis of cyclic thiocarbonates. Cyclo-di(cyclic dithiocarbonate) (Cyclo-DTC), NC-514-di(cyclic thiocarbonate) (NC-514-DTC), and glycerol tri(cyclic thiocarbonate) (GTTC) were synthesized as monomers for the preparation of NIPTU foam. (Chen, Y., et al., Macromolecules 2023, 56 (10), 3687-3702; Chen, Y., et al., Macromolecules 2024, 57 (2), 490-502.)

Determination of cyclic thiocarbonate equivalent weight (TEW). The cyclic thiocarbonate equivalent weights (TEW) of Cyclo-DTC, NC-514-DTC, and GTTC were determined through 1H NMR spectroscopy. 1,2,4,5-tetrachlorobenzene was used as an internal standard. The TEW values of Cyclo-DTC, NC-514-DTC, and GTTC were determined as 233 g/mol, 548 g/mol, and 225 g/mol, respectively. Data is not shown for H¹ NMR and C¹³ NMR information of Cyclo-DTC, NC-514-DTC, and GTTC.

Synthesis of non-isocyanate polythiourethane foam (NIPTUF (Cyclo, 1074, Ac)). The preparation of NIPTU foam involved a simple one-pot synthesis. A Flacktek Max20 cup was charged with Cyclo-DTC (1500 mg, 6.44 mmol), Priamine-1074 (1768 mg, 3.22 mmol of diamine molecule), Tegomer E-Si 2330 (196 mg, 6 wt % of total weight of amine and cyclic carbonate), and acetone (163 mg, 5 wt %), and was mixed for 10 min at 3500 rpm in a Flacktek speed mixer (DAC 150.1 FVZ-K). The homogeneous mixture was heated in an oven for 15 min at 80° C., during which a blown foam was observable. Afterwards, the material was left in the oven for further curing at 80° C. for 30 min.

Synthesis of non-isocyanate polythiourethane foam (NIPTUF (Cyclo, 1074, EA)). A Flacktek Max20 cup was charged with Cyclo-DTC (1500 mg, 6.44 mmol), Priamine-1074 (1768 mg, 3.22 mmol of diamine molecule), Tegomer E-Si 2330 (196 mg, 6 wt % of total weight of amine and cyclic carbonate), and ethyl acetate (163 mg, 5 wt %), and was mixed for 10 min at 3500 rpm in a Flacktek speed mixer (DAC 150.1 FVZ-K). The homogeneous mixture was heated in an oven for 25 min at 80° C., during which a blown foam was observable. Afterwards, the material was left in the oven for further curing at 80° C. for 30 min.

Synthesis of non-isocyanate polythiourethane foam (NIPTUF (NC514/GTTC, 1074, Ac)). A Flacktek Max20 cup was charged with NC-514-DTC (1000 mg, 1.82 mmol of cyclic thiocarbonate functional groups), GTTC (273 mg, 1.21 mmol of cyclic thiocarbonate functional groups) Priamine-1074 (832 mg, 1.52 mmol of diamine molecule), Tegomer E-Si 2330 (126.3 mg, 6 wt % of total weight of amine and cyclic carbonate), and ethyl acetate (105 mg, 5 wt %), and was mixed for 10 min at 3500 rpm in a Flacktek speed mixer (DAC 150.1 FVZ-K). The homogeneous mixture was heated in an oven for 10 min at 80° C., during which a blown foam was observable. Afterwards, the material was left in the oven for further curing at 80° C. for 20 min.

Scanning Electron Microscopy (SEM). The NIPTU foams were fractured to expose the cross-sectional area perpendicular to the rise direction, placed on individual flat aluminum sample holders, coated with 8 nm of osmium, and imaged with a Hitachi S3400 SEM at 5.0 kV. The cell-face area (A_{c}) and the area of the cell-face holes (Aₕ) were estimated with ImageJ software and averaged from 3 SEM images. The cell density (N_{cell}) was calculated according to eq 1:

$${N}_{cell} = {( \frac{nM}{A} )}^{3 / 2} \frac{{ρ}_{s o l i d}}{{ρ}_{f o a m}} \qquad ( 1 )$$

where n is the number of cells (averaged from three SEM images), M is the magnification factor, A is the area of the SEM image, ρ_{solid} is the density of NIPTU films, and ρ_{foam} is the foam density.

Hot compression molding for foam-to-film recycling and film reprocessing. A compression molder (PHI press, model 0230C-X1) was used for compression molding foam-to-film recycling of NIPTU foam and the subsequent reprocessing of the film. This process, denoted as foam-to-film recycling, involved the application of heat and force by the compression molder, destroying the porous structure of the foam and facilitating dynamic chemistry. For foam-to-film recycling, a virgin NIPTU foam sample was cut using a razor blade into mm-size bits and then placed between two metal plates covered with a layer of Kapton tape. The foam pieces were successfully compression molded into ˜1 mm thick sheets with 10-ton ram force (˜16 MPa) at one of three separate conditions: 140° C. for 10 min, 160° C. for 5 min, or 180° C. for 3 min. This resulted in compression molding a foam-to-film sample, namely 1^{st} mold Comp-film. The 1^{st} mold Comp-film was further reprocessed by cutting the sample into bits and remolding at 180° C. for 3 min to obtain the 2^{nd} mold Comp-film sample.

Foam-to-film recycling using a twin-screw extruder by free extrusion or pseudo-injection molding. A twin-screw extruder (HAAKE MiniLab 3, Thermo Scientific) was used for free extrusion or injection molding foam-to-film recycling. Virgin NIPTU foam (˜5 g) was ground into small particles under liquid nitrogen for each experiment. For free extrusion foam-to-film recycling, the extruder was set to 180° C. with a 40-rpm rotation rate before feeding the materials. The particles were then continuously fed into the extruder, with an estimated residence time of 3 min before the sample was extruded, yielding Ext-film sample. For injection molding foam-to-film recycling, the extruder was set to 180° C. with a 20-rpm rotation rate before feeding the materials. The mixture was continuously fed into the extruder, filling a backflow channel with a mold cavity emulating injection molding. Following feeding, the material underwent circulation for 10 min. After 10 min, the rotation was stopped, and the temperature was reduced, allowing the formation of a solid sample. The film sample within the mold cavity was obtained as Inj-film sample.

Catalyst-free foam-to-foam recycling using pseudo-injection molding connected to twin-screw extruder. A twin-screw extruder (HAAKE MiniLab 3, Thermo Scientific) was used for foam-to-foam recycling or refoaming. Virgin NIPTU foam (˜5 g) was ground into small particles under liquid nitrogen. 8 wt % (relative to the weight of NIPTU foam) of the physical blowing agent sodium bicarbonate (NaHCO₃) was added and physically mixed with the small particles. The screw rotation rate was set to 20 rpm and the temperature was set to 120° C. before the materials were fed. The mixture was continuously fed into the twin-screw extruder at 120° C., utilizing a circulation mode where the material filled the backflow channel and was led back to the twin screw. After the material was cycled at 120° C. for 5 min, the temperature of the extruder was raised to 140° C. for another 2 min, after which the temperature was further raised to 160° C. After the temperature was maintained at 160° C. for 2 min, the lid was opened, and the resulting refoamed sample was obtained.

NIP TU foam self-healing experiments. The self-healing properties of NIPTU foam were tested by two methods. For the first method, a NIPTU foam strip was cut into halves using a fresh, PTFE-coated stainless steel razor blade. Then the halves were immediately pressed against each other at the cut interfaces and kept in a covered glass petri dish to minimize contamination. Healing was allowed to occur at 120° C. for 12 h. For the second method, a piece of NIPTU foam was torn open by hands, after which the damaged foam was healed under the same condition as used in the first method. All healing results were visualized using a Bruker Contour GT Optical Profiler. Optical images were captured using the microscope on the profiler.

Dynamic mechanical analysis (DM A). A TA Instruments RSA-G2 Solids Analyzer was used to measure the tensile storage modulus (E′), tensile loss modulus (E″), and the damping ratio (tan δ=E″/E′) as functions of temperature. Rectangular specimens (8 mm×4 mm×1 mm) were heated from −30° C. to 150° C. under N₂ atmosphere at a heating rate of 3° C./min. Measurements were done in tension at a frequency of 1 Hz and 0.03% oscillatory strain. Tension-mode stress relaxation experiments were done on rectangular-cut samples using a TA Instruments RSA-G2 Solids Analyzer, and each sample was thermally equilibrated for 5 min at the testing temperature. An instantaneous, constant 5% strain was applied during testing, and the stress relaxation modulus (E(t)) for each sample was monitored as a function of time until at least 75% relaxation of its initial value. For compression tests, the compression samples were directly collected from the Max20 cup after synthesis; the top and bottom parts were sanded with sandpaper to give a level surface. Compression tests were performed at a strain rate of 0.02 mm/s until a total strain of 50%, acquiring data at a frequency of 10 Hz. Cyclic compression hysteresis tests were performed at a strain rate of 0.02 mm/s until a total strain of 50%; 3 min intervals were applied between load and unload cycles.

FTIR Spectroscopy. ATR-FTIR spectroscopy was performed using a Bruker Tensor 37 FTIR spectrophotometer with a diamond/ZnSe attachment. Samples were scanned at room temperature with a 4 cm⁻¹ resolution over 4000-600 cm⁻¹ range.

¹H NMR Spectroscopy. ¹H NMR spectra were recorded at room temperature using a Bruker AVANCE III 500 MHz NMR spectrometer. Chemical shifts were quoted in ppm relative to tetramethylsilane (TMS), using the residual solvent peak as the reference standard.

Differential Scanning calorimetry (DSC). A Mettler Toledo DSC822e was used to characterize the T_{g}. Samples were first heated to 140° C. at a rate of 10° C./min and maintained for 5 min, followed by cooling to −40° C. at a rate of −40° C./min. The dried sample T_{g} values were obtained from a second heating ramp from −40° C. to 140° C. at a 10° C./min rate using the ½ ΔCₚ method.

Thermogravimetric analysis (TGA). TGA was performed using a Mettler Toledo TGA/DSC3+. Samples were heated under a nitrogen atmosphere from 25° C. to 650° C. at a 10° C./min heating rate. The change in weight was recorded as a function of temperature.

Swelling. Small pieces of the NIPTU foam and recycled film samples (˜100-150 mg) were immersed in THF (˜18 mL) at room temperature. The samples were left to swell for 48 h to equilibrium. Then, an excess amount of tri-n-butylphosphine (1:2 molar ratio to DTC groups) and a few drops of DI water were added into THF, and the swelling was allowed for another 24 h.

### Results and Discussion

Synthesis of catalyst-free bio-based NIPTU foam. In the synthesis of bulk NIPTU networks, cyclic dithiocarbonate (DTC) underwent ring-opening reactions with amines to form thionourethane crosslinks. In the ring-opening process, the amine underwent regioselective nucleophilic addition with the S—C(S) bond in DTCs, resulting in increased selectivity and the formation of 100% primary thiols. The resulting NIPTU networks were fully reprocessable; compared to structurally analogous PHU networks, NIPTU networks exhibited more rapid synthesis, improved mechanical strength, and enhanced water resistance.

This Example demonstrates the preparation of NIPTU foams with characteristics superior to other NIPU foams. In the initial attempt, GTTC, a trifunctional DTC, was reacted with Priamine-1074, a difunctional amine, to create a network structure (as a gelling reaction), in the presence of Tegomer® E-Si 2330 surfactant, and acetone was used as a physical blowing agent (as foaming reaction). However, in the absence of a solvent, the polymer mixture gelled even before proper mixing of the monomers, at a rate close to a click reaction, leaving no time for the physical blowing agent to vaporize and form bubbles at a suitable network strength.

Achieving homogenous foam formation requires a delicate balance between foaming and gelling. It is crucial for the foaming process (which is the vaporization of acetone in this Example) to occur at the optimal viscoelastic properties of the polymer solution, i.e., with a network strength that is sufficiently high to prevent bubble collapse yet not so high as to suppress bubble nucleation. In the initial attempt where trifunctional cyclic thiocarbonate and difunctional amine were reacted, the exceedingly fast gelling reaction due to the high reactivity of trifunctional cyclic thiocarbonate rapidly led to a high network strength that suppressed bubble nucleation. To address the challenge, in the next set of experiments, only difunctional monomers were used to construct NIPTU with linear backbone bearing pendant thiol groups. Therefore, instead of the rapid reaction between trifunctional cyclic thiocarbonate and amine, the gelling reaction depended on the relatively slower formation of disulfide crosslinks from thiol auto-oxidation. As such, the gelling reaction rate could be matched with the rate of foaming. Hence, there was a larger timescale window to allow foaming prior to gelation of the polymer solution.

To validate this approach, a biobased difunctional DTC, Cyclo-DTC, that can be derived from rice husks was selected as a replacement for the trifunctional GTTC. With the difunctional aliphatic amine Priamine-1074, derived from natural oil, a high biobased content NIPTU with linear backbones can be generated. (See FIG. 2A.) The first demonstration of a NIPTU foam was achieved via a one-pot synthesis where a stoichiometric balance of Cyclo-DTC and Priamine-1074, 6 wt % of Tegomer® E-Si 2330 as surfactant, and 5 wt % of acetone (Ac) as blowing agent were mixed homogeneously before being heated to 80° C. Capitalizing on the interplay of fast ring-opening of DTC to create backbones and the slightly slower thiol auto-oxidation to create crosslinks, the gelling time nicely synchronized with the vaporization of acetone. A microcellular foam, referred to as NIPTUF (Cyclo, 1074, Ac), was produced after 15 min of reaction and an additional 30 minutes for post-curing. (See FIG. 2B.)

Swelling tests were performed on the as-synthesized virgin NIPTU foam (NIPTUF (Cyclo, 1074, A c)) to prove the formation of a crosslinked network. After being immersed in THF for 48 h, the virgin NIPTU foam obviously swelled but remained integrated, consistent with its crosslinked nature. (Data not shown) To demonstrate the existence of disulfide bonds from thiol-auto oxidation, an excess amount of tri-n-butylphosphine, a commonly used disulfide reducing agent, accompanied with a few drops of water, was added to the NIPTU foam at 48 h of swelling in THF. After another 24 h, the virgin NIPTU foam partially dissolved and disintegrated into shards. (Data not shown) This can be attributed to the fact that tri-n-butylphosphine substantially reduces the levels of the disulfide bonds, which in turn proves the existence of disulfide crosslinks due to thiol auto-oxidation. (Imbernon, L. et al., Polym. Chem. 2015, 6, 4271-4278.) Moreover, the observation that NIPTU foam partially dissolved after disulfide reduction indicated that the NIPTU foam bore linear backbones that were solely crosslinked with disulfide bonds.

Having successfully synthesized the first example of purely NIPTU foam, it was investigated whether the synthesis methodology could be applied to other formulations. The objective was also to determine whether adjustments in formulation could be utilized to modulate the cellular morphologies or mechanical characteristics of the resulting foams. First, the physical blowing agent was changed from 5 wt % acetone (Ac, boiling point of ˜56° C.) to 5 wt % ethyl acetate (EA, boiling point of ˜77° C.), which is a more environmentally friendly solvent. The foaming process for NIPTUF (Cyclo, 1074, EA) proved successful (see FIG. 7). However, this switch from acetone to ethyl acetate led to an extended foaming time. One possible reason is that with the increasing boiling point of the physical blowing agent, both the physical transition and diffusion of the gas were slower, while the crosslinking rate of the foam was unchanged, effectively nucleating the bubbles in a highly viscous medium. In addition to changing the blowing agent, different DTC choices were also tested. A mixture of GTTC and NC-514-DTC (40 mol % and 60 mol % of cyclic thiocarbonate functional groups with respect to amine functional groups) were reacted with Priamine-1074 in the presence of surfactant and acetone as blowing agents. The NC-514-DTC was included with GTTC to lower the concentration of DTC functional groups and the gelling rate. NIPTUF (NC-514/GTTC, 1074, Ac) was generated within 10 min of reaction (see FIG. 8). The successful syntheses of NIPTUFs were supported by FTIR (data not shown), where the band at 1110 cm⁻¹ was assignable to the C═S bond in the N—C(═S)—O moiety from the thionourethane linkages, consistent with the reaction between DTC and amine groups. The band at 3325 cm⁻¹ was assignable to —NH— moieties, also consistent with successful NIPTU synthesis.

NIPTU foam properties: physical properties, morphology, mechanical and thermal properties. The cell morphology of the NIPTU foams were characterized by scanning electron microscopy (SEM) in FIGS. 3A-3C and summarized in Table 1. The average cell diameter (d_{cell}) and the degree of open-cell morphology were evaluated, quantified by the ratio of the cell-face holes (Aₕ) to the area of the cells (A_{c}). It was found that d_{cell} of the acetone-blown NIPTUF (Cyclo, 1074, Ac) was higher than that of the ethyl-acetate-blown NIPTUF (Cyclo, 1074, EA) foam. Additionally, it was noted that the density of the NIPTUF (Cyclo, 1074, Ac) was lower than the density of the NIPTUF (Cyclo, 1074, EA) foam. This may be rationalized by the fact that ethyl acetate has a higher boiling point than acetone (77° C. vs. 56° C.). At the reaction T (80° C.), the foaming formulation was well above the boiling point of acetone, resulting in vigorous vaporization and a faster rate of foaming and, thereby, larger d_{cell} and lower density. In contrast, with ethyl acetate, the foaming rate was significantly slower, thereby allowing more disulfide crosslinks to form and increasing the viscosity during foaming, resulting in smaller d_{cell} and higher density. Nevertheless, both NIPTU foams were categorized as low-density foams with open-cell morphologies, making them highly suitable for comfort purposes, such as for cushioning and furniture underfilling. Additionally, the NIPTUF (NC-514/GTTC, 1074, Ac) exhibited a higher density with smaller d_{cell} than NIPTUF (Cyclo, 1074, Ac) and NIPTUF (Cyclo, 1074, EA). This further illustrates the multiple avenues to tuning the morphology and physical properties of NIPTU foams, paralleling the versatility of PU foam properties.

TABLE 1
Physical, morphological, and mechanical properties of all virgin NIPTU foams.

| | Density^{a} | d_{cell}^{b} | | N_{cell}^{d} | T_{g}^{e} | E_{comp}^{f} | σ_{65%}^{g} |
|---|---|---|---|---|---|---|---|
| Sample | (g cm⁻³) | (mm) | Aₕ/A_{c}^{c} | (cells cm⁻³) | (° C.) | (kPa) | (kPa) |
| NIPTUF(Cyclo, | 0.14 ± | 0.54 ± | 0.079 | 28 × | 9 | 30 | 40 |
| 1074, Ac) | 0.03 | 0.18 | | 10³ | | | |
| NIPTUF(Cyclo, | 0.23 ± | 0.35 ± | 0.064 | 53 × | 9 | 45 | 53 |
| 1074, EA) | 0.02 | 0.12 | | 10³ | | | |
| NIPTUF(NC- | 0.30 ± | 0.30 ± | 0.11 | 43 × | 21 | 203 | 100 |
| 514/GTTC, 1074, | 0.04 | 0.09 | | 10³ | | | |
| Ac) | | | | | | | |

^{a}Error bars are one standard deviation.
^{b}Cell diameter error bars are one standard deviation, from three SEM images.
^{c}Determined from the ratio of the average areas of cell-face holes (Aₕ) and areas of the cells (A_{c}) of three SEM images.
^{d}Cell density, calculated from eq 2.
^{e}T_{g} values were measured via DSC and calculated using the ½ ΔCₚ method.
^{f}Compressive modulus, determined from the slope of the linear elastic region of the compressive stress-strain curve.
^{g}Compressive strength, determined from the stress at 65% compressive strain.

Because commercial PU foams are often utilized under compressive stresses, the compressive properties of the NIPTU foams were evaluated. The compressive stress-strain curves of all three foams, shown in FIG. 3D, displayed three deformation regions. The first region, the linear elastic deformation, had a slope corresponding to compressive modulus (E_{comp}). The second region, i.e., the plateau region, denoted cell collapse; for soft and semi-rigid foams, a quasi-linear plateau region was observed. Finally, the third region was associated with densification, and the compressive strength of the foams could be determined by the stress at 65% strain (σ_{65%}). The compressive behavior of NIPTUF (NC-514/GTTC, 1074, Ac) was markedly stronger, with E_{comp} of 203 kPa and σ_{65%} of 100 kPa; these were collectively within the range for semi-rigid PU foams. In contrast, the compressive properties of NIPTUF (Cyclo, 1074, Ac) and NIPTUF (Cyclo, 1074, EA) were within range for flexible PU foams, with E_{comp} and σ_{65%} on the order of 10 kPa. This showcases the tunability of the mechanical strength of NIPTU foams by simply changing the choice of monomers or crosslink densities. Hysteresis testing of NIPTUF (Cyclo, 1074, Ac) was also performed, and a low hysteresis loss of 16% was obtained, classifying it as a high resiliency foam (data not shown).

The trend of glass transition temperature (T_{g}) also aligned with the trend shown in compressive properties. The T_{g}s for NIPTUF (Cyclo, 1074, Ac) and NIPTUF (Cyclo, 1074, EA) were both 9° C. whereas that of NIPTUF (NC-514/GTTC, 1074, Ac) was 21° C., very close to room temperature, consistent with the observations that NIPTUF (Cyclo, 1074, EA) and NIPTUF (Cyclo, 1074, Ac) are flexible foams whereas NIPTUF (NC-514/GTTC, 1074, Ac) is a semi-rigid foam (data not shown). More importantly, in the NIPTU examples, changes in the blowing agent (with other things being equal) did not drastically modify T_{g} or mechanical properties, as T_{g} is a function of the polymer backbone structures. Accordingly, incorporation of a trifunctional DTC (as is the case for NIPTUF (NC-514/GTTC, 1074, Ac), resulted in a marked increase in T_{g} and compressive properties, owing to the introduction of thiourethane crosslinks. With these results, the facile tunability of NIPTU foam properties was demonstrated for the first time. Attaining such control of properties is crucial to open up the application space of NIPTU foams as potential alternatives to PU foams.

Achieving rapid foam-to-film reprocessing via hot compression molding and proof-of-principle self-healing by leveraging the rapid dynamic chemistry of disulfide crosslinks. In view of the emphasis on achieving true circularity for thermosets, the inventors sought to explore the reprocessability of the NIPTU foams through a number of means. The inventors envisioned achieving rapid reprocessability, self-healability, and extrudability for the NIPTU foams, owing to the fast dynamic chemistry of the disulfide crosslinks. Subsequent sections will exclusively focus on NIPTUF (Cyclo, 1074, Ac), as a proof-of-principle demonstration of the facile reprocessability of the NIPTUF materials. Thermogravimetric analysis (TGA) was initially performed to assess the thermal stability of NIPTUF (Cyclo, 1074, Ac), and a degradation temperature (determined as the temperature at 5% mass loss, or T_{95%}) was obtained at 245° C. (data not shown). This ensured that subsequent reprocessing conditions were much milder than those needed to induce thermal degradation.

To investigate the dynamic character of NIPTUF (Cyclo, 1074, Ac), stress relaxation experiments were performed on the 1^{st}-mold compression-molded film at 140-190° C. The relaxation curves were fitted with the Kohlrausch-Williams-Watts (KWW) stretched exponential decay function, which generally has been found to provide a much better fit for CANs than the single-exponential-decay Maxwell model:

$$\frac{E ( t )}{{E}_{0}} = exp [ - {( \frac{t}{{τ}^{*}} )}^{β} ] \qquad ( 2 )$$

where E(t)/E₀ is the normalized modulus at time t, τ* is the characteristic relaxation time, and β (0<β≤1) is the stretching exponent that serves as a shape parameter characterizing the breadth of the relaxation distribution. The average relaxation time, <τ>, is given by:

$$〈 τ 〉 = \frac{{τ}^{*} Γ ( \frac{1}{β} )}{β} \qquad ( 3 )$$

where Γ represents the gamma function. The stress relaxation results are given in Table 2. Notably, the 1^{st} mold Comp-films display rapid stress relaxation, with <τ> <3 min at temperatures of 160° C. and above. Moreover, it was determined that that apparent Arrhenius activation energy for stress relaxation (Eₐ) was 106 kJ/mol. This value is consistent with disulfide exchange being the dominant operative dynamic chemistry.

TABLE 2
Characteristic relaxation times τ*, stretching exponent
β, average relaxation times <τ>, and Arrhenius
activation energy values from stress relaxation measurements.

| T | τ* | | <τ> | | Eₐ | |
|---|---|---|---|---|---|---|
| (° C.) | (s) | β | (s) | R² | (kJ/mol) | R² |
| 140 | 869 | 0.62 | 1280 | 0.999 | 106 ± 4 | 0.995 |
| 150 | 584 | 0.63 | 799 | 0.998 | | |
| 160 | 288 | 0.73 | 350 | 0.999 | | |
| 170 | 143 | 0.78 | 165 | 0.999 | | |
| 180 | 80 | 0.81 | 90 | 0.999 | | |
| 190 | 47 | 0.85 | 52 | 0.999 | | |

Motivated by the rapid dynamic behavior observed in NIPTUF (Cyclo, 1074, Ac) through stress relaxation results, investigations into its recyclability were conducted. Using hot compression molding, foam-to-film recycling was performed at one of three temperatures (140° C., 160° C., and 180° C.), aligning with the testing temperatures used for stress relaxation experiments. Remarkably, successful foam-to-film recycling was observed at 140° C. for 10 min, leading to an intact, solid film devoid of any cellular structures. (See FIG. 4C) Additionally, foam-to-film recycling was successfully conducted at 160° C. for 5 min and at 180° C. for 3 min. (See FIG. 4C.) These short processing timescales via hot compression molding highlight the extraordinarily rapid dynamic chemistry exhibited in NIPTUF (Cyclo, 1074, A c), surpassing most reported works on CANs.

To demonstrate the reprocessability of the film resulting from compression molding foam-to-film recycling, the film obtained from compression molding was further reprocessed for 3 min at 180° C. (marked as the 1^{st} mold Comp-film) by cutting the film into mm-size bits and remolding at the same condition, yielding the 2^{nd} mold Comp-film. Both molds of the film as well as the virgin NIPTU were characterized using DM A. As shown in FIG. 4D, as temperature increased above T_{g}, there was a sharp decrease in tensile storage modulus (E′) and the peak of damping ratio (tan δ); the virgin foam and the two different molds of Comp-films each exhibited rubbery plateaus, indicative of their crosslinked network structures upon the formation of disulfide crosslinks. By compressing the virgin foam into Comp-films, a significant increase of E′ was observed in both glassy state and rubbery state, confirming the transformation of the cellular virgin foam into bulk films. After reprocessing the 1^{st} mold Comp-film by cut-and-remold method, the 2^{nd} mold Comp-film displayed tan S and E′ curves overlapping with the 1^{st} mold Comp-film (FIG. 5C and Table 3). Accounting for the fact that the modulus in the rubbery plateau region of an ideally crosslinked network is proportional to its crosslink density, the overlapping E′ rubbery plateau values of the two films indicated that, after reprocessing, the 2^{nd} mold Comp-film fully recovered the original crosslink density in the 1^{st} mold Comp-film. These DMA results illustrate the excellent and rapid recyclability of the NIPTU foam through both foam-to-film recycling and film-to-film recycling.

TABLE 3
Rubbery plateau modulus (E′) of NIPTU (Cyclo, 1074) materials.

| | E′ at 130° C. |
|---|---|
| Sample | (MPa) |
| Virgin foam | 0.082 ± 0.002 |
| 1st-mold Comp film | 1.43 ± 0.07 |
| 2nd-mold Comp film | 1.52 ± 0.05 |
| Ext-film | 1.27 ± 0.10 |
| Inj-film | 1.47 ± 0.04 |
| Refoamed | 0.152 ± 0.02 |

Next, it was hypothesized that the rapid disulfide exchange could lead to self-healing capability for NIPTUF (Cyclo, 1074, Ac). As a demonstration, the virgin NIPTUF (Cyclo, 1074, Ac) was mechanically damaged by cutting a strip of foam using a razor blade, and the foam was subjected to heating at 120° C. without applying any external force. (See FIG. 4E) After 12 h of heating, the two halves of the foam fused together at the cutting surfaces, as observed under a stereo microscope. (See FIG. 4F) In another demonstration, a small piece of NIPTU foam was torn open by hand to induce more irregular damage. After 8 h at 120° C., the fusion of the foam was observed at the crack. (Data not shown) Nevertheless, the fused foam samples from both healing experiments could be ripped open under force applied by hand, prohibiting further mechanical testing to assess the healing. This can be attributed to the limited contact area at the damage interface due to the cellular structure of NIPTU foam. The fact that NIPTU foam still exhibited such partial self-healing properties reveals the dynamic character provided by the inter-chain disulfide crosslinks.

Foam-to-film recycling using a twin-screw extruder. Having demonstrated effective reprocessability and self-healability in batch processes, other continuous, advanced recycling techniques for NIPTUF (Cyclo, 1074, Ac) were explored. Extrusion and injection molding are among the most widely utilized commercial methods for processing polymers, with extrusion enabling continuous processing and injection molding allowing for the production of materials in designated shapes. However, a large number of reported CANs fail to meet the flowability requirements for these processes due to their excessively long relaxation times stemming from slow dynamic chemistry, e.g., traditional PU networks require external catalysis to accelerate the dynamic chemistry for extrusion, and successful extrusion of PHU networks has not been reported. Hence, given the extraordinarily rapid recyclability of the NIPTU foam under catalyst-free conditions, assessing its compatibility with extrusion and injection molding is of great interest.

The virgin NIPTUF (Cyclo, 1074, Ac) was ground, and the foam particles were fed into a twin-screw extruder at 180° C. and a 40-rpm rotation speed. The extrudate appeared as a fully dense sample with film-like dimensions. The extrudate was then marked as Ext-film. (See FIG. 5A) In another attempt, the extruder flow was redirected from free extrusion to a backflow channel with a cavity emulating injection molding. (See FIG. 5B) After 10 min of circulation under the same condition, the extruder was stopped and allowed to cool. A solidified film sample was obtained with the same shape as the injection molding cavity. The injection molded sample was denoted as Inj-film. (See FIG. 5B) As indicated by DMA results in FIG. 5C, both Ext-film and Inj-film exhibited rubbery plateau E′ significantly higher than that of virgin foam and, within experimental error, the same as that of Comp-film shown in FIG. 4D. (See also Table 3.) This confirms that at 180° C., NIPTU foam was successfully recycled into solid samples with no cellular structure via both free extrusion and emulated injection molding.

Catalyst-free foam-to-foam recycling using injection molding connected to a twin-screw extruder. Studies were undertaken to recycle the NIPTU foam by blending in a blowing agent to achieve refoaming. NaHCO₃ was chosen as the blowing agent for its relatively mild decomposition conditions and release of benign gases. Specifically, the pre-mixed NIPTU virgin foam granules and NaHCO₃ powder were fed into the twin-screw extruder at 20 rpm and 120° C., a relatively low temperature to avoid premature decomposition of NaHCO₃ during feeding. The sample melt was directed to the backflow channel with a mold cavity and circulated for 5 min. This step facilitated homogeneous dispersion of NaHCO₃, due to the enhanced melt flow of the sample as a result of the dynamic disulfide exchange. Subsequently, the temperature was raised to 140° C. in 2 min to induce NaHCO₃ decomposition into CO₂. It was noted that the CO₂ gas would dissolve within the polymer due to high pressures within the working extruder. Finally, the temperature was further increased to 160° C., at which point the lid of the extruder was rapidly opened. This led to the sudden pressure drop of the sample within the extruder, triggering bubble nucleation and volumetric expansion of the extrudate. Meanwhile, the disulfide crosslinks rapidly re-formed due to the temperature decrease, which led to the restoration of network strength to trap the bubbles and prevent cell collapse.

This interplay resulted in the formation of a cellular structure shown in FIG. 6B, with d_{cell} of 0.17 mm (FIG. 6C), and a density of 0.65 g/cm³. These results provide evidence that a refoamed, porous NIPTU material was recovered from the extruder. Moreover, through TGA experiments on the refoamed NIPTU (Cyclo, 1074), no mass loss was observed at 120-160° C., certifying that all NaHCO₃ had been consumed (data not shown). Further, DMA characterization of the refoamed NIPTU foam indicated a slightly higher E′ value relative to that of the virgin foam, in both the glassy and rubbery state. This can be attributed to the increased foam density of the refoamed material, and is consistent with general fundamental relationship between foam mechanical property and relative density. Likewise, a similar trend was observed regarding the compressive properties of the refoamed material, with E comp of 142 kPa and a compressive strength of 180 kPa, which are both considerably higher than those of the virgin foam. Nevertheless, this was the first proof-of-principle of a fully recyclable and refoamable example of a catalyst-free, isocyanate-free PU alternative.

TABLE 4
Physical, morphological, and mechanical properties of refoamed NIPTU foam.

| | Density^{a} | d_{cell}^{b} | | N_{cell}^{d} | T_{g}^{e} | E_{comp}^{f} | σ_{65%}^{g} |
|---|---|---|---|---|---|---|---|
| Sample | (g cm⁻³) | (mm) | Aₕ/A_{c}^{c} | (cells cm⁻³) | (° C.) | (kPa) | (kPa) |
| NIPTUF(Cyclo, | 0.65 ± | 0.17 ± | 0.012 | 740 | 7 | 142 | 180 |
| 1074, Ac) - | 0.07 | 0.08 | | | | | |
| refoamed | | | | | | | |

^{a}Error bars are one standard deviation.
^{b}Cell diameter error bars are one standard deviation, from three SEM images.
^{c}Determined from the ratio of the average areas of cell-face holes (Aₕ) and areas of the cells (A_{c}) of three SEM images.
^{d}Cell density, calculated from eq 2.
^{e}T_{g} value was measured via DSC and calculated using the ½ ΔCₚ method
^{f}Compressive modulus, determined from the slope of the linear elastic region of the compressive stress-strain curve.
^{g}Compressive strength, determined from the stress at 65% compressive strain.

CONCLUSIONS. The inventors have developed a series of non-isocyanate polythiourethane (NIPTU) foams through a catalyst-free synthesis aided by physical blowing agents, e.g., acetone or ethyl acetate. Crosslinking in these systems occurs through the auto-oxidation of the pendant thiol groups into disulfides, affording highly dynamic disulfide crosslinks. A swelling test was performed to prove the existence of disulfide bonds as the only crosslinks. In examples of foams synthesized from difunctional monomers (Cyclo-DTC and Priamine-1074), it was demonstrated that acetone-blown foams produce lower density foams with larger cell sizes than ethyl-acetate-blown foams, due to the difference in boiling points affecting the rate of foaming. Importantly, these foams are highly elastic and have T_{g} of 9° C., classifying them as flexible soft foams. In another example where a trifunctional DTC was incorporated in conjunction with a difunctional DTC (GTTC and NC-514, respectively), excellent mechanical property and T_{g} enhancements were demonstrated, classifying the foams as semi-rigid foams. This Example highlights the modular design of biobased NIPTU foams, allowing for tunability of morphology, physical, and mechanical properties through facile approaches.

The reprocessability of the NIPTU foams were subsequently investigated in view of the circular polymer economy. Stress relaxation measurements of a reprocessed bulk film demonstrated the catalyst-free, rapid relaxation of the disulfide dynamic crosslinks, allowing for the reprocessing of the spent NIPTU foam at 140, 160, and 180° C. for 10, 5, and 3 min, respectively, which are among the fastest in CANs. Moreover, the self-healability of the NIPTU foam was highlighted, showing the disappearance of the fractured surface at 120° C. under ambient atmospheric pressures. M ore excitingly, the extremely fast relaxation at 160° C. and above motivated the exploration of continuous reprocessing techniques, such as extrusion. It was demonstrated that the spent NIPTU foams can be extruded and pseudo-injection molded into bulk materials at 180° C. with properties equal to films reprocessed through compression molding. Then, for the first time, foam-to-foam recycling of non-isocyanate polyurethane (NIPU) foams was demonstrated using the NIPTUs as an example. By mixing a small amount of sodium bicarbonate (NaHCO₃) into the spent foams prior to extrusion, CO₂ gas was generated during extrusion due to the decomposition of NaHCO₃, leading to a cellular structure. Ultimately, this Example highlights the superior sustainability advantages of NIPTU foams: amenability towards a family of reprocessing techniques: self-healing, compression-moldability, extrusion into bulk films, and culminating in foam-to-foam extrusions.

The following data is not provided (but found in U.S. provisional patent application No. 63/639,848, filed Apr. 29, 2024, the entire contents of which are incorporated herein by reference): ¹H NMR and ¹³C NMR spectra of epoxies and DTCs. Synthesis of NIPTUF (Cyclo, 1074, EA) and NIPTUF (NC-514/GTTC, 1074, Ac), FTIR spectra, DSC, TGA curves, swelling ratio and gel contents of NIPTU materials, Compressive stress-strain curves of NIPTU foams, Hysteresis of NIPTUF (Cyclo, 1074, Ac)

### Example 2

This Example illustrates the use of an NIPTU film (“film”) and an NIPTU foam (“foam”) made by foam-to-film and foam-to-foam reprocessing the NIPTU foam, (cyclo, 1074, Ac), as described in Example 1, as a pad for chemical mechanical polishing (CMP).

Additional information, including data indicated as being not shown, may be found in U.S. provisional patent application No. 63/639,848, filed Apr. 29, 2024, the entire contents of which are incorporated herein by reference.

The screening techniques described are accepted by the CM P research community as a viable screening method. The comparative analysis provides information about interactions that occur and the critical 3-body interface (pad/slurry/wafer) that give rise to effective CM P performance such as removal rate and defectivity.

Potentiodynamic analysis (Tafel Analysis) was performed using a Gamry Reference 600 potentiostat. This setup utilized a 3-electrode system consisting of a saturated calomel reference electrode, a platinum counter electrode, and a copper rotating disk working electrode. The sample area of the Cu electrode was 1.327 cm² and had a density of 8.96 g/cm³. Industry-standard Cu slurry formulations (300 g) were prepared with 1.0 ml of 1.0 wt. % potassium nitrate (KNO₃) as the supporting electrolyte. Each measurement was performed under dynamic conditions, in which the working electrode was rotated at 50 RPM during collection time. A pad sample was secured to the bottom of the dish, and the working electrode was placed in contact with the pad at a total downforce of 1 PSI prior to initiation of rotation. During rotation, the pad sample remained in contact with the Cu electrode, covering it entirely. The corrosion current (Icorr) values were obtained by measuring the current at the intersection of the tangent lines of the cathodic and anodic curves. A summary of the Tafel analysis for a widely used commercial Cu slurry was obtained (data not shown).

The extrusion and foam pad samples performed very similarly to one another; however, they were more corrosive compared to the IC1000. This may be the result for two reasons: 1) the pad was grooved in the case of the IC1000, which will transport the slurry waste away from the surface more effectively. The waste was known to catalyze enhanced removal rate. 2) The NIPTU foam pad samples may in fact have increased slurry adsorption and thus produced a chemically active interface, which was evident from the shifts in both the anodic and cathodic regions of the Tafel plot.

The next level of analysis was to determine the ability of the slurry to provide an environment on the surface of the pad that has an adequate fluid film thickness to promote CM P removal rate performance. This also will address the aforementioned issue of enhanced wettability (i.e., surface energy changes) that may result in improved interfacial chemical activity. Pad samples were placed on the stand and ensured to be flat. The recording was initiated using a CASIO Exilim HS EX-ZR 700 at 120 FPS and 4.2× zoom. A 15 μL drop of the respective chemistry was pipetted onto the pad's surface, and recording continued until 5 min had elapsed. Time interval images of the video were obtained every 30 sec using Frameshots software (open source, FrameShots.com). The drop contact angle of each time interval was analyzed via Image J software using the Drop Analysis-LB-ADSA plugin (data not shown).

Along with being more chemically active, the pad samples were also more wettable with an industry standard Cu slurry. The variability in the samples potentially came from the surface roughness and pore structure. Surface roughness analysis was run on a 3d Profilometer (Filmetrics®), where the samples were run using GLI at a fast scan speed. The scan length was around 150 μm (with the exception of the foam pad, which was 700 μm), and the zoom was 10× physical and 1× digital. Once the images were run, they were uploaded to ProfilmOnline to be processed for area roughness. Processing steps included leveling the image, filling any invalid particles, and removing outlier noise. The standard for roughness measurements was ASME B 46.1 3D. After the initial measurements, each sample was dipped into deionized water and dragged 4 times along the conditioner from center to edge. This step was repeated 4 times, with each repeat alternating between vertical scratching and horizontal scratching.

The most visual change post-conditioning could be observed with the extrusion pad, as distinctive scratching could be seen running along the sample both vertically and horizontally, while the IC1000 only had slight scratching, and the NIPTU foam pad had no noticeable scratching. This similarity in behavior between the IC1000 and the extrusion pad was also observed with the change in arithmetic mean height (Sₐ) and the squared mean height (S_{q}), as both samples saw a slight decrease post-conditioning while the foam pad saw an increase. (data not shown)

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the disclosure has been presented for purposes of illustration and of description. It is not intended to be exhaustive or to limit the invention to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the invention in various embodiments and with various modifications as suited to the particular use contemplated. It is intended that the scope of the invention be defined by the claims appended hereto and their equivalents.

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value

Unless otherwise indicated, and in recognition of the inherent nature of the techniques described herein, throughout the present disclosure, terms and phrases such as “absence,” “free,” “does not comprise,” etc. encompass, but do not require a perfect absence of the referenced entity.

Unless otherwise indicated, the term “type” as used herein refers to chemical formula such that a single type means the same chemical formula and different type means different chemical formula. Similarly, use of “more” as in “one or more” refers to use of different types of the relevant entity.

Throughout the present disclosure, terms such as “comprising” and the like may be replaced with terms such as “consisting” and the like.

What is claimed is:

1. A method of forming a disulfide-crosslinked non-isocyanate polythiourethane (NIPTU) foam, the method comprising:
reacting a difunctional cyclic dithiocarbonate and a diamine in the presence of a blowing agent to form a NIPTU foam having a solid matrix comprising linear non-isocyanate polythiourethane chains crosslinked by interchain disulfide crosslinks, wherein surfaces of the solid matrix define a plurality of pores distributed throughout.

2. The method of claim 1, wherein the NIPTU foam is free of thiourethane crosslinks.

3. The method of claim 1, wherein crosslinks in the NIPTU foam consist of the interchain disulfide crosslinks.

4. The method of claim 1, wherein the difunctional cyclic dithiocarbonate has two cyclic 5-membered dithiocarbonate groups connected by a polyether group.

5. The method of claim 1, wherein the linear non-isocyanate polythiourethane chains each comprise groups selected from 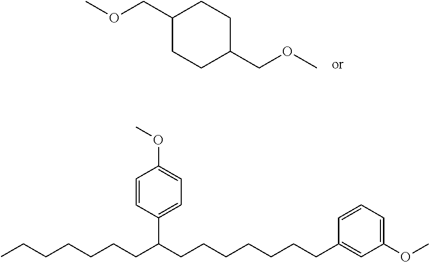
or both.

6. The method of claim 1, wherein the diamine is a H₂N—R₂—NH₂, wherein R₂ is an aliphatic group.

7. The method of claim 6, wherein R₂ is

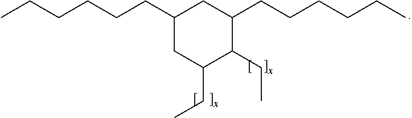

8. The method of claim 1, wherein the blowing agent is a physical blowing agent that does not react with the difunctional cyclic dithiocarbonate or the diamine.

9. The method of claim 1, wherein the blowing agent is selected from acetone, an alkyl alkanoate, or a combination thereof.

10. The method of claim 1, wherein the reacting step takes place in absence of an aminolysis catalyst and in absence of an oxidizing agent and the NIPTU foam is free of unreacted difunctional cyclic dithiocarbonate, free of unreacted diamine, and free of unreacted thiol groups.

11. The method of claim 1, wherein the difunctional cyclic dithiocarbonate and the diamine are provided by a foaming formulation comprising no more than 50 mol. % of a tri- or higher functional thiocarbonate and no more than 50 mol. % of a tri- or higher functional amine.

12. The method of claim 11, wherein the foaming formulation comprises a trifunctional cyclic dithiocarbonate at an amount of no more than 40 mol. %.

13. The method of claim 1, wherein the difunctional cyclic dithiocarbonate and the diamine are provided by a foaming formulation consisting of the difunctional cyclic dithiocarbonate, the diamine, the blowing agent, a surfactant, and optionally, one or more of a tri- or higher functional thiocarbonate and a tri- or higher functional amine.

14. The method of claim 13, wherein the foaming formulation consists of the difunctional cyclic dithiocarbonate, the diamine, the blowing agent, the surfactant, and optionally, a trifunctional cyclic dithiocarbonate.

15. The method of claim 14, wherein the linear non-isocyanate polythiourethane chains each comprise groups selected from 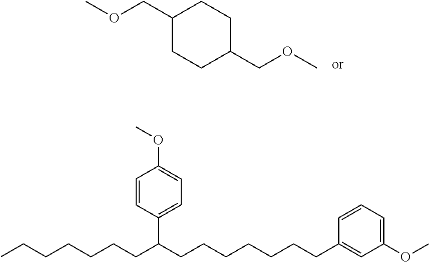
or both;
further wherein the diamine is H₂N—R₂—NH₂, wherein R₂ is 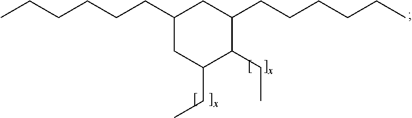
further wherein the blowing agent is acetone, an alkyl alkanoate, or a combination thereof; and
further wherein the trifunctional cyclic dithiocarbonate is glycerol tri(cyclic thiocarbonate).

16. The method of claim 15, wherein the foaming formulation consists of the difunctional cyclic dithiocarbonate, the diamine, the blowing agent, and the surfactant.

17. A disulfide-crosslinked non-isocyanate polythiourethane (NIPTU) foam having a solid matrix comprising linear non-isocyanate polythiourethane chains crosslinked by interchain disulfide crosslinks, wherein surfaces of the solid matrix define a plurality of pores distributed throughout, and further wherein the linear non-isocyanate polythiourethane chains are the reaction product of difunctional cyclic dithiocarbonate monomers and diamine monomers.

18. A method of reprocessing the NIPTU foam of claim 17, the method comprising:
mixing a blowing agent with the disulfide-crosslinked NIPTU foam to form a mixture;
heating the mixture under a pressure greater than atmospheric pressure to a temperature at which the blowing agent produces a gas that dissolves in a melt of the linear non-isocyanate polythiourethane chains and which induces disulfide bond dissociation; and
reducing the pressure on the mixture to a pressure at which the dissolved gas is released and forms bubbles and reducing the temperature of the mixture to a temperature at which interchain disulfide crosslinks reform, to provide a reprocessed, disulfide-crosslinked NIPTU foam.

19. A method of reprocessing the NIPTU foam of claim 17, the method comprising:
heating and reshaping the disulfide-crosslinked NIPTU foam at a temperature to eliminate pores therein and to induce disulfide bond dissociation to create a non-isocyanate polythiourethane film; and
cooling the non-isocyanate polythiourethane film to a temperature at which interchain disulfide crosslinks reform.

20. The method of claim 19, wherein at least 85% of a disulfide crosslink density of the non-isocyanate polythiourethane film is recovered after the reprocessing.
